(19) United States
(12) Patent Application Publication
(10) Pub. No.: US 2026/0318288 A1
(43) Pub. Date: Oct. 15, 2026

(54) PUMP FOR DISPENSING A FLUID PRODUCT

(71) Applicant: APTAR FRANCE SAS, LE NEUBOURG (FR)

(72) Inventor: Ludovic PETIT, VITOT (FR)

(73) Assignee: APTAR FRANCE SAS, LE NEUBOURG (FR)

(21) Appl. No.: 19/481,285

(22) PCT Filed: May 3, 2024
(86) PCT No.: PCT/FR2024/050578

§ 371 Date: Nov. 4, 2025

(30) Foreign Application Priority Data
May 5, 2023 (FR) FR2304543

(51) Int. Cl. F04B 9/14; B05B 11/10

(52) U.S. Cl. CPC F04B 9/14; B05B 11/1088

(57) ABSTRACT

A pump for dispensing a fluid product including a pump body containing a pump chamber, a piston sliding inside the pump body between a rest and actuation positions, an elastic return member for returning the pump to its rest position after each actuation, and a deformable element for generating a precompression at the start of actuation. The deformable element includes a hollow cylindrical tube of a deformable material, such as an elastomer, in particular an thermoplastic elastomer, the hollow tube arranged radially inside the piston and, in the rest position of the piston, slightly deformed radially inwards by a radially projecting profile. The hollow tube, during actuation, folded radially inwards when a threshold actuation force is exerted by the user on the piston.

The present invention relates to a pump for dispensing a fluid product.

The documents FR2343137 and FR2403465 describe a pump comprising a pump body in which a piston can move, mounted to slide on an actuating rod, the thrust force exerted on the rod by the user being transmitted to the piston by means of a spring, so that, by actuating the actuating rod, a relative movement of the piston relative to the rod occurs.

Document WO2020128269A1 describes an improved version of the above pump.

Those pumps may however present certain drawbacks. Thus, they have two metal springs, which is not advantageous from a recycling point of view. In addition, they comprise a gland, cooperating with the return spring and necessary to achieve the start-up of the pump.

Documents CN216270996, CN114889977, WO2023003387 and FR2678906 describe other pumps of the state of the art.

The purpose of the invention is to provide a fluid product dispensing pump that does not have the above-mentioned disadvantages.

Thus, the present invention also aims to provide a pump for dispensing a fluid product which improves the recycling by eliminating the metallic springs.

Thus, the present invention also aims to provide a pump for dispensing a fluid product which simplifies the start-up.

Another object of the present invention is to provide a pump for dispensing a fluid product that is simple and inexpensive to manufacture and assemble.

The present invention thus provides a pump for dispensing a fluid product, the pump comprising a pump body containing a pump chamber, a piston that slides inside said pump body between a rest position and an actuation position, a resilient return member for returning said pump to its rest position after each actuation, and a deformable element for generating a precompression at the start of each actuation, said deformable element comprising a hollow cylindrical tube made of a deformable material, such as an elastomer, in particular a thermoplastic elastomer, said hollow tube being arranged radially inside said piston, and being, in the rest position of said piston, slightly deformed radially inwards by a radially projecting profile, said hollow tube, during actuation, folding radially inwards when a threshold actuation force is exerted by the user on said piston.

Advantageously, one of said hollow tube and said piston comprises said radially projecting profile which, in the rest position of said piston, is in contact with the other of said hollow tube and said piston, in order to carry out said slight radial inward deformation of said hollow tube in the rest position of said piston.

Advantageously, said radially projecting profile is a radially projecting outer profile formed on said hollow tube and projecting radially outwards from said hollow tube to cooperate, in the rest position, with said piston.

Alternatively, said radially projecting profile is a radially projecting inner profile formed on said piston and projecting radially inwards from said piston to cooperate, in the rest position, with said hollow tube.

Advantageously, said radially protruding profile is a peripheral rib.

Alternatively, said radially projecting profile comprises a plurality of lugs arranged around the periphery of said hollow tube or said piston, over the same axial height.

Advantageously, said radially projecting profile is arranged axially approximately in the middle of said hollow tube or said piston.

Advantageously, said pump body comprises an upper opening closed by said piston and a lower opening closed by an inlet valve, held in place by a valve holder fixed in said pump body, said piston sealingly sliding in said pump body around a hollow axial rod connected to said dispensing head, said hollow axial rod being provided with an inner axial channel axially closed on the lower side and communicating with the outside by a radial hole, said piston having, on an outer radial edge, an outer sealing lip, configured to seal against said pump body, and on an inner radial edge, an inner sealing lip, configured to seal said radial hole when it is in the non-operating state,

Advantageously, said tube rests on the upper axial side on a shoulder of said hollow axial rod and on the lower axial side on said piston.

Advantageously, a hollow axial insert is fixed in said hollow axial rod, said hollow axial insert having said radial hole.

Advantageously, said elastic return member is non-metallic.

Advantageously, said resilient return member is a bellows disposed between said dispensing head and a part mounted on said pump body, such as a fixing ring.

Advantageously, a fixing ring is provided to fix said pump body on a reservoir with a neck seal interposed therebetween, a ring seal being provided for ensuring the sealing of said fixing ring with said pump body.

Advantageously, in the non-operating position, an upper axial edge of said piston cooperates in a sealed manner with said ring seal.

The present invention further provides a device for dispensing a fluid product comprising a dispensing head provided with a dispensing hole, said dispensing head being assembled on a pump as described above.

These features and advantages and others will appear more clearly during the detailed description below, made in reference to the accompanying drawings, given as non-limiting examples, and wherein:

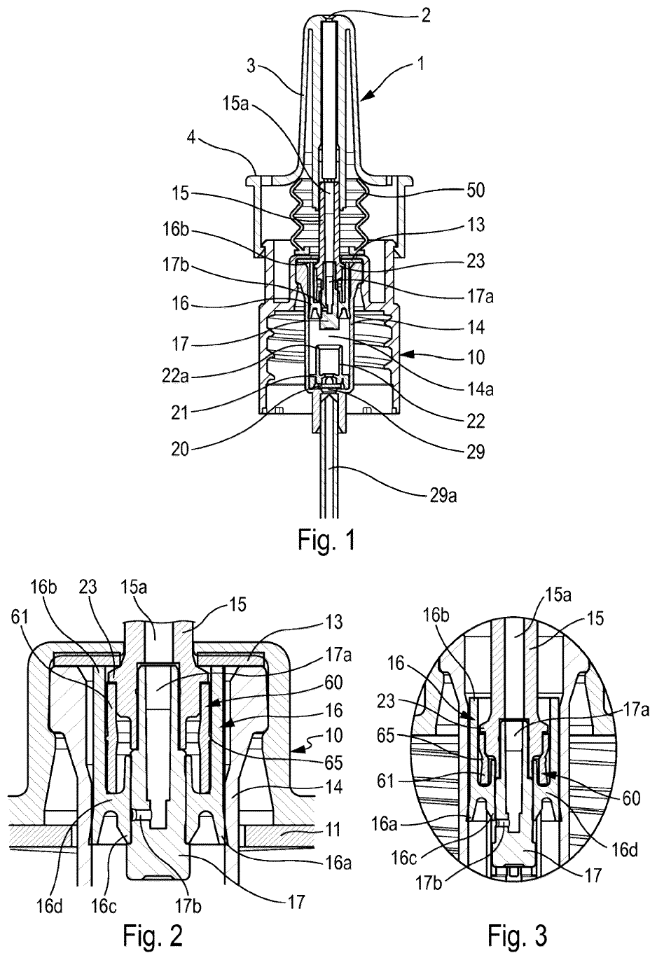

FIG. 1 is a diagrammatic section view of a fluid dispenser device including a fluid dispenser pump constituting an advantageous embodiment of the invention, in its rest position;

FIGS. 2 and 3 are diagrammatic cross-sectional detail views showing the precompression of the pump of FIG. 1, respectively before and during actuation.

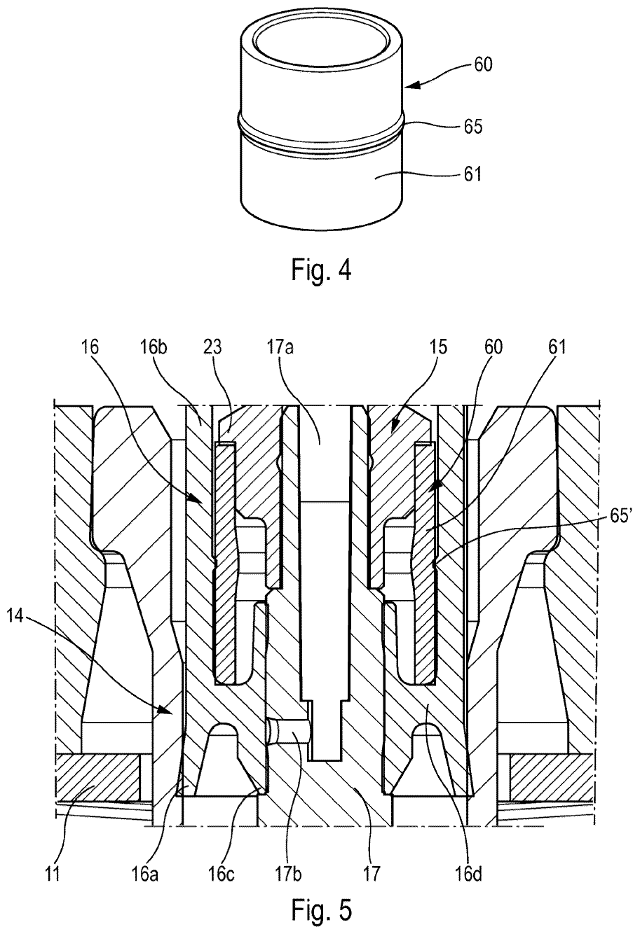

FIG. 4 is a diagrammatic perspective view of the deformable element producing the precompression, and

FIG. 5 is a view similar to the view in FIG. 2, showing a second advantageous embodiment;

In the description, the terms “top”, “bottom”, “upwards”, and “downwards” are relative to the upright position of the device shown in the Figures. The terms “axial” and “radial” refer to the longitudinal central axis of the pump.

FIG. 1 shows a pump according to a first advantageous embodiment of the invention, which improves a pump of the prior art as described in document WO2020128269A1.

This pump comprises a pump body 14 containing a pump chamber 14a. The pump body 14 is axially open on both sides, with an upper opening closed by a piston 16 and a lower opening 29 advantageously closed by an inlet valve 20.

A fixing ring 10 is provided to fix the pump body 14 on the neck of a reservoir (not represented) preferably with a neck seal 11 interposed therebetween. A ring seal 13 ensures the sealing of the fastening ring 10 with the pump body 14.

A piston 16 sealingly slides in the pump body 14, between a rest position and an actuation position, advantageously around a hollow axial rod 15, with an inner axial channel 15a.

The first inner axial channel 15a opens axially towards the top of the rod 15 to connect to a dispensing head 1 provided with a dispensing hole 2.

The dispensing head 1 advantageously comprises a nasal tip 3 intended to be at least partially inserted into a nostril during use, as well as a radial flange 4 forming a support for the user's fingers during actuation.

Towards the bottom, the first inner axial channel 15a is also advantageously axially open and the hollow axial rod 15 advantageously receives a hollow axial insert 17.

This hollow axial insert 17 comprises a second inner axial channel 17a which opens axially upwards into the first inner axial channel 15a of the hollow axial rod 15.

Towards the bottom, the second internal axial channel 17a is advantageously axially closed, and the hollow axial insert advantageously has a radial hole 17b to connect the second internal axial channel 17a with the outside of the hollow axial insert 17.

Optionally, the rod 15 and the insert 17 could be formed as a single piece, for example by moulding.

An elastic return member 50, advantageously non-metallic, is provided to bias said pump towards its non-operating position, and to guide it back to this non-operating position after each actuation.

In the example represented, this resilient return member 50 is formed by a bellows arranged between the dispensing head 1 and the fixing ring 10, which resiliently biases the dispensing head towards its non-operating position. During actuation, this bellows 50 is compressed, such that after actuation, the compressed bellows will resiliently return towards its non-compressed position, driving with it, the dispensing head 1 towards its non-operating position, which in turn, returns the piston 16 towards its non-operating position by suctioning the next dose of fluid product into the pump chamber 14a.

An outer radial edge of the piston 16 advantageously forms an outer sealing lip 16a, for ensuring the sealing with respect to the internal surface of the pump body 14.

An upper axial edge 16b of the piston 16 advantageously ensures, in the non-operation state, the sealing against the ring seal 13.

The pump body 14 is advantageously closed towards the bottom by the inlet valve 20, held in place by a valve holder 21. This inlet valve closes an opening 29, communicating with the interior of the reservoir, and to which a dip tube 29a can be connected, in the well-known conventional manner.

The rod 15 advantageously comprises a shoulder 23 which particularly serves to limit the upward movement of the rod 15, by forming an abutment with the ring seal 13.

When the pump is at rest, the upper edge 16b of the piston 16 is advantageously applied against the ring seal 13.

The sealing between the piston 16 and the hollow axial insert 17 is advantageously ensured by an internal portion of the piston 16, preferably of conical shape, forming an inner sealing lip 31.

The outer 16a and inner 16c sealing lips advantageously extend axially downwards from a radial bottom wall 16d, as can be seen in particular in FIGS. 2, 3 and 5.

In the non-operating state, the radial hole 17b is advantageously in line with the inner sealing lip 16c, so as to be fully closed. The sealing between the outside and the inside of the reservoir is therefore advantageously ensured on the one hand by the contact between the upper edge 16b of the piston 16 and the ring seal 13, and on the other hand between the inner sealing lip 31 and the hollow axial insert 17.

To achieve a precompression during actuation, which makes it possible, in particular, to ensure a good dispensing of the entire dose without risk of partial actuation stroke, the pump comprises a deformable element 60.

This deformable element 60 comprises a hollow cylindrical tube 61 made out of a deformable material, for example an elastomer, in particular a thermoplastic elastomer.

This tube 61 is arranged radially inside the piston 16, advantageously resting on the upper axial side on the shoulder 23 of the rod and on the lower axial side on said piston 16, in particular on the radial bottom wall 16d.

Thus, the deformable element 60 transmits to the piston 16 the actuating force exerted by the user on the rod 15, and it is only when this deformable element 60 deforms that the rod 15 will be able to move axially in the piston 16.

FIGS. 2 and 3 show this precompression.

According to the invention, the hollow tube 61 is, in the rest position of the piston 16, slightly deformed radially inwards by a radially projecting profile 65, 65′.

Advantageously, one of the hollow tube 61 and the piston 16 comprises said radially projecting profile 65, 65′ which, in the rest position of the piston 16, is in contact with the other of said hollow tube 61 and said piston 16, in order to carry out the slight radial inward deformation of the hollow tube 61 in the rest position of the piston.

In the first embodiment shown in FIGS. 1 to 4, the tube 61 comprises on its outer radial surface the radially projecting outer profile 65 which projects radially outwards from said tube 61.

This radially projecting outer profile 65 can advantageously be a peripheral rib, as illustrated in FIG. 4, but in a variant it could be composed of a plurality of lugs arranged all around the periphery of the tube 61 on the same axial height thereof.

Advantageously, the radially projecting outer profile 65 is arranged axially approximately in the middle of said tube 61, but other implementations are possible.

Thus, at rest, the tube 61 is arranged radially close to the piston 16, radially inside the latter, and the presence of the radially projecting outer profile 65 generates a small inwards deformation of said tube 61, as can be seen in FIG. 2.

In the second embodiment of FIG. 5, the radially projecting outer profile 65 of the tube 61 is removed and replaced by a radially projecting inner profile 65′ made in the inner surface of the piston 16 and projecting radially inwards from the piston 16.

The result is the same, namely that at rest, the tube 61 is slightly deformed radially to the inside at this radially projecting inner profile 65′, which will cause an inwards radial deformation of the tube 61 during actuation.

As for the first embodiment, this radially projecting inner profile 65′ may advantageously be a peripheral rib, but in a variant it could be composed of a plurality of lugs arranged all around the periphery of the piston 16 over the same axial height thereof.

Advantageously, the radially projecting inner profile 65 is arranged axially approximately in the middle of said tube 61, but other implementations are possible.

At the start Of the actuation stroke, the force exerted by the user on the dispensing head will be transmitted via the shoulder 23 of the rod 15 to said deformable element 60, which, from a threshold force, will be able to deform by folding radially inwards, due to this small initial deformation already present at rest.

The resistance to that elastic deformation generates resistance to actuation, and therefore precompression, which requires a certain threshold force to actuate the pump.

In addition, this elastic deformation of the deformable element 60 elastically biases the piston 16 towards its non-operating position, in which the internal sealing lip 16c of the piston closes the radial hole 17b of the hollow axial insert 17.

Thus, after each actuation, as soon as the user releases its pressure on the dispensing head 1, the piston 16 automatically returns to its position of closing the radial hole 17b, thus allowing the pump chamber 14a to be loaded with a new dose of fluid product aspirated from the reservoir.

A vent (not represented) can advantageously be provided in the pump body 14 to allow the product expelled by the pump 14 to be replaced by air on each actuation.

The pump described above operates as follows. In the non-operating state, the sealing inside the reservoir is ensured by the neck seal 11 between the ring 10 and the reservoir (not shown), by the ring seal 13 between the ring 10 and the pump body 14, by the contact between the upper edge 16b of the piston 16 and the ring seal 13, and by the inner sealing lip 31 of the piston 16 against the hollow axial insert 17.

The reservoir, not shown in the drawings, and which may be any, is filled with a liquid, in particular a pharmaceutical liquid, to be dispensed, in particular to be sprayed.

The fixing ring 10 can be made of plastic material. It can be screwed, crimped, snap-fitted or otherwise fixed on the reservoir.

The user must first start-up the pump by operating it to expel the air until the pump chamber 14a is filled with liquid.

During start-up, the air contained in the pump chamber 14a is compressed, and it is by a mechanical abutment between the valve holder 21 and the piston 16 that the insert 17 and the rod 15 can move relative to the piston 16 to open the radial hole 17b and allow the compressed air to be expelled.

When the pump returns to the non-operating position, liquid is sucked into the pump chamber 14a through the dip tube 29a, in a well-known manner.

Advantageously, the valve holder 21 comprises an axial sleeve 22 projecting axially upwards, the upper edge 22a of which cooperates during start-up with the piston 16, in particular the inner sealing lip 16c, to move the piston 16 axially upwards, to open the radial hole 17b and discharge the air contained in the pump chamber 14a.

The pump therefore makes it possible to achieve a reliable start-up without using an additional part, such as a gland, interspersed between the piston 16 and the rod 15 and/or the insert 17, as is the case in the pump of document WO2020128269A1.

After start-up, the pump is ready to be used to dispense a dose of liquid upon each actuation.

To perform such an actuation, the user presses axially on the dispensing head 1 to push in the rod 15. With the liquid being incompressible, the piston 16 moves around the insert 17 while deforming the deformable element 60. When the pressure is sufficient to overcome the resistance to deformation of the deformable element 60, the piston 16 uncovers the radial hole 17b, discharging the liquid out of the pump chamber 14a.

The liquid is rapidly expelled through the radial hole 17b, the second internal channel 17a and the first internal channel 15a, towards the dispensing head 1 assembled on the pump.

Thereafter, the user ceases to exert pressure on the rod 15. The deformable element 60 immediately urges the piston 16 to return to its non-operating position, which ensures the closing of the radial hole 17b, and closes the pump chamber 14 a relative to the dispensing head 1. At the same time, the bellows 50 guide the dispensing head 1 back into its non-operating position, which drives the rod 15 and the insert 17 upwards. This creates a depression in the pump chamber 14a so that, liquid is sucked through the hole 29, lifting the valve 20, while air replaces this liquid in the reservoir, passing through the central opening of the ring seal 13 around the rod 15, and advantageously through the vent 35.

When the upper edge 16b of the piston 16 comes into contact with the ring seal 13, the air can no longer enter, and the piston 16 is blocked, the pump has returned to its non-operating position and is ready for a new actuation.

An advantage of the pump shown in FIG. 1 is that it has no metal parts, which on the one hand makes the manufacture and assembly of the pump less complex and therefore less expensive, and which on the other hand is advantageous for recycling.

Another advantage is that the pump ensures a reliable start-up without an intermediate part between the piston and the rod and/or the insert.

The present invention has been described with reference to two advantageous embodiments, but naturally any modification could be applied thereto by the person skilled in the art, without going beyond the scope of the present invention, as defined by the accompanying claims.

1-15. (canceled)

16. A pump for dispensing a fluid product comprising a pump body containing a pump chamber, a piston that slides inside said pump body between a rest position and an actuation position, an elastic return member for returning said pump to its rest position after each actuation, and a deformable element for generating a precompression at the start of each actuation, characterised in that said deformable element comprises a hollow cylindrical tube made of a deformable material, such as an elastomer, in particular an thermoplastic elastomer, said hollow tube being arranged radially inside said piston, and being one of said hollow tube and said piston comprising a radially projecting profile which, in the rest position of said piston, is in contact with the other of said hollow tube and said piston so that in said rest position, said hollow tube is slightly deformed radially inwards by a radially projecting profile, said hollow tube, during actuation, being folded radially inwards when a threshold actuation force is exerted by the user on said piston.

17. The pump according to claim 16, wherein said radially projecting profile is a radially projecting outer profile formed on said hollow tube and projecting radially outwards from said hollow tube to cooperate, in the rest position, with said piston.

18. The pump according to claim 16, wherein said radially projecting profile is a radially projecting inner profile formed on said piston and projecting radially inwards from said piston to cooperate, in the rest position, with said hollow tube.

19. The pump according to claim 16, wherein said radially projecting profile is a peripheral rib.

20. The pump according to claim 16, wherein said radially projecting profile comprises a plurality of lugs arranged around the periphery of said hollow tube or said piston, over the same axial height.

21. The pump according to claim 16, wherein said radially projecting profile is arranged axially approximately in the middle of said hollow tube or said piston.

22. The pump according to claim 16, wherein said pump body comprises an upper opening closed by said piston and a lower opening closed by an inlet valve, held in place by a valve holder fixed in said pump body, said piston sealingly sliding in said pump body around a hollow axial rod connected to said dispensing head, said hollow axial rod being provided with an inner axial channel axially closed on the lower side and communicating with the outside by a radial hole, said piston having, on an outer radial edge, an outer sealing lip, configured to seal against said pump body, and on an inner radial edge, an inner sealing lip, configured to seal said radial hole when it is in the non-operating state,

23. The pump according to claim 22, wherein said tube is supported on the upper axial side on a shoulder of said hollow axial rod and on the lower axial side on said piston.

24. The pump according to claim 22, wherein a hollow axial insert is fixed in said hollow axial rod, said hollow axial insert having said radial hole.

25. The pump according to claim 16, wherein said elastic return member is non-metallic.

26. The pump according to claim 25, wherein said resilient return member is a bellows disposed between said dispensing head and a part fixed on said pump body, such as a fixing ring.

27. The pump according to claim 16, wherein a fastening ring is provided for fastening said pump body on a container with a neck seal interposed therebetween, a ring seal being provided for ensuring the sealing of said fastening ring with said pump body.

28. The pump according to claim 27, wherein, in the rest position, an upper axial edge of said piston cooperates in a sealed manner with said ring seal.

29. Device for dispensing a fluid product comprising a dispensing head provided with a dispensing hole, said dispensing head being assembled on a pump according to claim 16.
